(19) United States
(12) Patent Application Publication
(10) Pub. No.: US 2004/0201988 A1
(43) Pub. Date: Oct. 14, 2004

(54) LED light string and arrays with improved harmonics and optimized power utilization

(75) Inventor: David Allen, Yardley, PA (US)

Correspondence Address: LINIAK, BERENATO & WHITE, LLC, 6550 ROCK SPRING DRIVE, SUITE 240, BETHESDA, MD, 20817, US

(73) Assignee: FIBER OPTIC DESIGNS, INC., Yardley, PA (US)

(21) Appl. No.: 10/839,335

(22) Filed: May 6, 2004

Related U.S. Application Data
(63) Continuation-in-part of application No. 10/243,835, filed on Sep. 16, 2002.
Application No. 10/243,835 is a continuation of application No. 09/819,736, filed on Mar. 29, 2001, now Pat. No. 6,461,019.
Application No. 09/819,736 is a continuation-in-part of application No. 09/378,631, filed on Aug. 20, 1999, now abandoned.
Application No. 09/378,631 is a continuation-in-part of application No. 09/339,616, filed on Jun. 24, 1999.
(60) Provisional application No. 60/119,804, filed on Feb. 12, 1999.

(51) Int. Cl. F21V 21/00

(52) U.S. Cl. 362/249; 362/227

(57) ABSTRACT

An AC driven LED light string assembly is provided possessing reduced harmonic distortion and improved electrical efficiency when one or more series blocks of LED lamps is employed. In one embodiment, there is provided an LED light string employing a capacitor coupled in parallel across the light string AC input, or end connector terminals. According to another embodiment, LED light strings are to be manufactured with a substantially equal number of light strings produced with all LEDs in forward bias (anode first) and reverse bias (cathode first). This allows true randomness when large numbers of single series block LED light strings are connected in an end-to-end manner. It is possible to apply this concept to single LED lamps having two chips where one chip is powered in reverse bias to the second chip; thereby providing self-canceling harmonics within the single LED lamp.

This application is a continuation-in-part of application Ser. No. 10/243,835 filed Sep. 16, 2002, which is a continuation of copending application Ser. No. 09/819,736 filed Mar. 29, 2001, which is a continuation-in-part of copending application Ser. No. 09/378,631 filed Aug. 20, 1999, which is a continuation-in-part of copending application Ser. No. 09/339,616 filed Jun. 24, 1999. This application claims benefit of U.S. Provisional Application No. 60/119,804, filed Feb. 12, 1999. The disclosures of the aforementioned applications are incorporated herein by reference.

### BACKGROUND OF THE INVENTION

1. Field of Invention

The present invention relates to light emitting diode assemblies, light strings comprising a plurality of light emitting diode assemblies, especially light strings employing light emitting diodes, and related methods.

2. Description of Related Art

Light emitting diodes (LEDs) are increasingly employed as a basic lighting source in a variety of forms, including decorative lighting, for reasons among the following. First, as part of an assembly, LEDs have a very long lifespan, compared with common incandescent and fluorescent sources. For example, a typical LED lifespan is at least 100,000 hours. Second, LEDs have several favorable physical properties, including ruggedness, cool operation, and ability to operate under wide temperature variations. Third, LEDs are currently available in all primary and several secondary colors, as well as in a “white” form employing a blue source and phosphors. Fourth, with newer doping techniques, LEDs are becoming increasingly efficient, and colored LED sources currently available may consume an order of magnitude less power than incandescent bulbs of equivalent light output. Moreover, with expanding applications and resulting larger volume demand, as well as with new manufacturing techniques, LEDs are increasingly cost effective.

Tests have established that LED light strings use only 2 to 5% of the power of an incandescent string, although they produce less light. However, the light output of LEDs has improved significantly over the past years and continues to so.

LED-containing holiday and decorative light sets, such as used for decorative purposes such as for Christmas lighting, typically employ series-parallel construction. This is particularly true when LED light strings are driven using line-voltage Alternating Current (typically 110-220 VAC). AC driven LED light strings employing a single series block of LEDs, or multiple series blocks of LEDs connected in parallel and oriented in the same polarity exhibit a high percentage of DC and harmonic content as well as poor power utilization. Harmonic distortion caused by widespread use of AC driven LED light strings presents serious transmission problems to electric utility providers.

When single series block, AC driven LED light strings are connected in parallel, DC and harmonic content becomes a random event depending on whether the strings are connected in an end-to-end manner using the same polarity or opposite polarity. However, this is not a truly random event as consumers tend to orient plugs in the same direction. The “stacking” of plugs, or use of common polarized plugs and end connectors in the construction of LED light strings removes the randomness factor entirely, further exacerbating DC and harmonic feedback problems.

AC driven LED light strings employing multiple series blocks connected in parallel will exhibit the same unbalanced waveform and percent harmonic content as single series block LED light strings when the series blocks are arranged in the same polarity. LED lights strings with balanced harmonics, or minimized harmonic distortion has not been addressed in prior art.

### SUMMARY OF THE INVENTION

This invention provides an AC driven LED light string capable of addressing one or more of the above-mentioned drawbacks.

This invention further provides an AC driven LED light string assembly possessing reduced harmonic distortion when a single series block of LED lamps is employed.

This invention further provides a method of manufacturing AC driven LED light strings with random polarity orientation when a single series block of LED lamps is employed.

This invention further provides an AC driven LED light string with balanced harmonics and DC content when multiple series blocks of LED lamps are employed, wherein harmonic distortion and DC content is self-canceling.

The invention further provides an AC driven LED light string with reduced harmonic content when multiple series blocks of LED lamps are employed and there is an uneven number of series blocks within the light string.

The invention further provides an AC driven LED light string with increased electrical efficiency, optimizing the percentage of power utilized.

It is another feature of the invention to provide a method for manufacturing the above, and to provide manufacturers with test procedures to assure harmonic content is reduced or eliminated.

To achieve one or more of the foregoing features of the invention, and in accordance with the purposes of the invention as embodied and broadly described in this document, according to a first aspect of this invention there is provided an AC driven LED light string employing a capacitor coupled in parallel across the light string AC input, or end connector terminals to greatly reduce harmonic distortion when a single series block of LEDs are used (FIG. 6A) (unbalanced harmonics and AC waveform). It is well known in the art that LED polarity must be maintained within a series block of LEDs. Capacitor specifications and properties are also well known in the art (Capacitors of 0.001 uF˜0.1 uF 500V were used depending on the AC input voltage employed).

According to a second aspect of this invention AC driven LED light strings employing a single series block of LED lamps should be manufactured with an equal number of light strings produced with all LEDs in forward bias (anode first) and reverse bias (cathode first). This allows true randomness when large numbers of single series block LED light strings are connected in an end-to-end manner. A simple sorting and test procedure is given later in this text to assist manufacturers and allow for an equal number of forward and reverse bias light strings. It is possible to apply this concept to single LED lamps having two chips where one chip is powered in reverse bias to the second chip; thereby providing self-canceling harmonics within the single LED lamp. Of course, this self-canceling concept can be employ to any even number of chips in a single LED lamp.

According to a third aspect of the invention AC driven LED arrays or light strings employing an even number of multiple LED series blocks (divisible by two) has an equal number of series blocks parallel connected in forward bias and reverse bias. This arrangement of LED series blocks presents an LED light string wherein harmonic and DC distortion is self-canceling (balanced harmonics and AC waveform) and percentage of power factors are optimized (FIG. 2B, FIG. 14, FIG. 15).

A fourth aspect of the invention provides an AC driven LED array or light string employing an odd number of multiple LED series blocks (not divisible by two) has an unequal number of LED series blocks connected in parallel in either forward, or reverse bias. In this event the unequal number of LED series blocks connected in forward, or reverse bias should equal one and a capacitor should be connected in parallel across the AC input, or end connector terminals to nearly eliminate DC and harmonic distortion (FIG. 6B). An alternate aspect of this invention would be to omit the capacitor, reducing DC and harmonic distortion somewhat, but not to the extent that it would be reduced by the inclusion of the capacitor (FIG. 6C). It should also be noted, as the number of series blocks increase DC interference and harmonic distortion are automatically reduced, provided the maximum balance of forward to reverse bias series blocks is maintained (FIG. 14).

In accordance with the fifth aspect of this invention, power utilization improves when the LED light strings are manufactured using near balanced harmonics and is optimized when balanced harmonics is achieved (FIG. 13).

In accordance with the sixth aspect of the invention, a method is provided for making the light string of this invention, in which the forward, or reverse bias direction of individual series blocks is identified by visual, or mechanical means thereby assisting the manufacturing process and greatly reducing defects and errors (FIG. 16).

In accordance with the seventh aspect of this invention a method is provided for manufacturers to test and sort (according to polarity, or LED orientation) single series block LED light strings (unbalanced harmonics), as well as LED light string employing multiple series blocks of LED lamps (balanced and near balanced) (FIG. 17).

Many of the foregoing concepts can be used simultaneously to reduce harmonic distortion and improve the power rating.

### BRIEF DESCRIPTION OF THE DRAWINGS

The accompanying drawings are incorporated in and constitute a part of the specification. The drawings, together with the general description given above and the detailed description of the certain preferred embodiments and methods given below, serve to explain the principles of the invention. In such drawings:

FIGS. 1A and 1B show two example block diagrams of the light string in its embodiment preferred primarily, with one diagram for a 110 VAC common household input electrical source (e.g., 60 Hz) and one diagram for a 220 VAC common household (e.g., 50 Hz) input electrical source.

FIG. 2A shows an example schematic diagram of an embodiment of this invention in which the diodes of the 50 LEDs (series) blocks 102 of FIG. 1 are connected in the same direction (unbalanced). This figure is provided as an example of the common series block arrangement utilized by manufacturers with poor power utilization and a high harmonic content.

FIG. 2B shows an example schematic diagram of an embodiment of this invention in which the diodes of the 50 LEDs (series) blocks 102 of FIG. 1 are connected in the reverse direction (balanced, self-canceling harmonics and DC content).

FIGS. 3A and 3B show two example block diagrams of the light string in its embodiment preferred alternatively, with one diagram for a 110 VAC common household input electrical source (e. g., 60 Hz) and one diagram for a 220 VAC common household (e.g., 50 Hz) input electrical source.

FIG. 4 shows an example schematic diagram of the AC-to-DC power supply corresponding to the two block diagrams in FIG. 3 for either the 110 VAC or the 220 VAC input electrical source.

FIGS. 5A and 5B show example pictorial diagrams of the manufactured light string in either its “straight” or “curtain” form (either form may be manufactured for 110 VAC or 220 VAC input).

FIG. 6A shows an example schematic diagram of an AC driven LED light string employing a single series block of LEDs and including a capacitor to reduce harmonic noise, or interference (improved harmonics).

FIG. 6B shows an example schematic diagram of an AC driven LED light string employing an unequal number of LED series blocks and including a capacitor to reduce harmonic noise, or interference (near balanced and improved harmonics).

FIG. 6C shows an example schematic diagram of an AC driven LED light string employing an unequal number of LED series blocks, but with the capacitor eliminated to reduce harmonic noise and interference to a lesser extent shown in FIGS. 6A and 6B.

FIG. 7 is a graph of current versus voltage for diodes and resistors.

FIGS. 8A and 8B are an additional schematic and block diagrams of direct drive embodiments with near balanced harmonics.

FIG. 9 is a plot showing the alternating current time response of a diode.

FIG. 10 is a graph showing measured diode average current response for alternating current and direct current.

FIG. 11 is a graph showing measured AlInGaP LED average and maximum AC current responses.

FIG. 12 is a graph showing measured light output power as a function of LED current.

FIG. 13 is a chart showing power utilization (percentage of power factors) for AC driven LED lights strings utilizing one or more series blocks in unbalanced (series blocks of same bias), near balanced (unequal number of series blocks in opposed bias), and balanced (equal number of series blocks in opposed bias) form.

FIG. 14 is a chart showing harmonic components for unbalanced, unbalanced with improved harmonics (filtered), near balanced, near balanced with improved harmonics (filtered), and balanced AC driven LED light strings

FIG. 15 is a graph showing the AC waveform for balanced and unbalanced AC driven LED light strings.

FIG. 16 is a pictorial diagram showing a simple method of maintaining forward and reverse bias between LED series blocks.

FIG. 17 is a pictorial diagram showing a simple method of testing bias of LED light strings employing single, or multiple series blocks.

### DETAILED DESCRIPTION OF CERTAIN PREFERRED EMBODIMENTS AND CERTAIN PREFERRED METHODS OF THE INVENTION

Reference will now be made in detail to the presently preferred embodiments and methods of the invention as illustrated in the accompanying drawings, in which like reference characters designate like or corresponding parts throughout the drawings. It should be noted, however, that the invention in its broader aspects is not limited to the specific details, representative assemblies and methods, and illustrative examples shown and described in this section in connection with the preferred embodiments and methods. The invention according to its various aspects is particularly pointed out and distinctly claimed in the attached claims read in view of this specification, and appropriate equivalents.

It is to be noted that, as used in the specification and the appended claims, the singular forms “a,” “an,” and “the” include plural referents unless the context clearly dictates.

The term “alternating current voltage”, sometimes abbreviated as “VAC”, as used herein occasionally refers to a numerical amount of volts, for example, “220 VAC”. It is to be understood that the stated number of alternating current volts is the nominal voltage which cycles continuously in forward and reverse bias and that the actual instantaneous voltage at a given point in time can differ from the nominal voltage number.

In accordance with an embodiment of the present invention, an LED light string employs a plurality of LEDs wired in series-parallel form, containing at least one series block of multiple LEDs. The series block size is determined by the ratio of the standard input voltage (e.g., either 110 VAC or 220 VAC) to the drive voltage(s) of the LEDs to be employed (e.g., 2 VAC). Further, multiple series blocks, if employed, are each of the same LED configuration (same number and kinds of LEDs), and are wired together along the string in parallel. LEDs of the light string may comprise either a single color LED or an LED including multiple sub-dies each of a different color. The LED lenses may be of any shape, and may be either clear, clear-colored, or diffuse-colored. Moreover, each LED may have internal circuitry to provide for intermittent on-off blinking and/or intermittent LED sub-die color changes. Individual LEDs of the light string may be arranged continuously (using the same color), or periodically (using multiple, alternating CIP colors), or pseudo-randomly (any order of multiple colors). The LED light string may provide an electrical interface to couple multiple light strings together in parallel, and physically from end to end. Fiber optic bundles or strands may also be coupled to individual LEDs to diffuse LED light output in a predetermined manner.

An LED light string of embodiments of the present invention may have the following advantages. The LED light string may last far longer and require less power consumption than light strings of incandescent lamps, and the light string may be safer to operate since less heat is generated. The LED light string may have reduced cost of manufacture by employing series-parallel blocks to allow operation directly from a standard household 110 VAC or 220 VAC source, either without any additional circuitry (AC drive), or with only minimal circuitry (DC drive). In addition, the LED light string may allow multiple strings to be conveniently connected together, using standard 110 VAC or 220 VAC plugs and sockets, desirably from end-to-end.

Direct AC drive of LED light string avoids any power conversion circuitry and additional wires; both of these items add cost to the light string. The additional wires impose additional mechanical constraint and they may also detract aesthetically from the decorative string. However, direct AC drive results in pulsed lighting. Although this pulsed lighting cannot be seen at typical AC drive frequencies (e.g. 50 or 60 Hz), the pulsing apparently may not be the most efficient use of each LED device because less overall light is produced than if the LEDs were continuously driven using DC. However, this effect may be compensated for by using higher LED current during each pulse, depending on the pulse duty factor. During “off” times, the LED has time to cool. It is shown that this method can actually result in a higher efficiency than DC drive, depending on the choice of AC current.

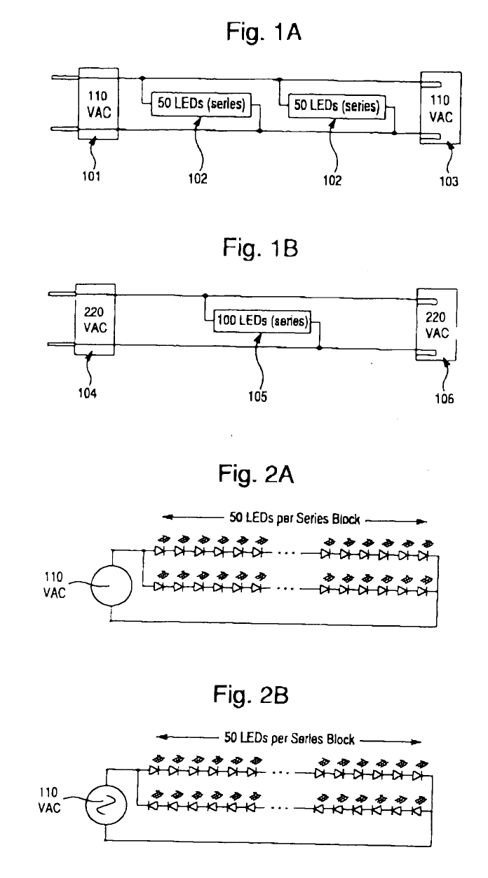

FIGS. 1A and 1B show the embodiment of an LED light string in accordance with the present invention, and as preferred primarily through AC drive. In FIG. 1A, the two block diagrams correspond to an exemplary string employing 100 LEDs, for either 110 VAC (top diagram) or 220 VAC (bottom diagram) standard household current input (e.g., 50 or 60 Hz). In the top block diagram of FIG. 1A, the input electrical interface consists merely of a standard 110 VAC household plug 101 attached to a pair of drive wires.

With the average LED drive voltage assumed to be approximately 2.2 VAC in FIG. 1A, the basic series block size for the top block diagram, corresponding to 110 VAC input, is approximately 50 LEDs. Thus, for the 110 VAC version, two series blocks of 50 2.2 VAC LEDs 102 are coupled in parallel to the drive wires along the light string. The two drive wires for the 110 VAC light string terminate in a standard 110 VAC household socket 103 to enable multiple strings to be connected in parallel electrically from end-to-end. The series block quantity of 50 LED lamps illustrated in FIG. 1A is used for example purposes only and could be larger, or smaller depending on the AC input voltage applied as well as the type of LED lamps used and the presence of current or voltage limiting circuitry (specifically not shown) as known in the art.

In the bottom block diagram of FIG. 1B, the input electrical interface likewise consists of a standard 220 VAC household plug 104 attached to a pair of drive wires. With again the average LED drive voltage assumed to be approximately 2.2 VAC in FIG. 1B, the basic series block size for the bottom diagram, corresponding to 220 VAC input, is 100 LEDs. Thus, for the 220 VAC version, only one series block of 100 LEDs 105 is coupled to the drive wires along the light string. The two drive wires for the 220 VAC light string terminate in a standard 220 VAC household socket 106 to enable multiple strings to be connected in parallel from end-to-end. Note that for either the 110 VAC or the 220 VAC light string, the standard plug and socket employed in the string varies in accordance to the country in which the light string is intended to be used. The series block quantity of 100 LED lamps illustrated in FIG. 1B is used for example purposes only and could be larger, or smaller depending on the AC input voltage applied as well as the type of LED lamps used and the presence of current or voltage limiting circuitry (specifically not shown) as known in the art.

Whenever AC drive is used and two or more series are incorporated in the light string, the first series blocks would be driven by either the positive or negative half of the AC voltage cycle. The only requirement of this embodiment is that, in each series block, the LEDs within the series block are wired with the same polarity and subsequent series blocks are wired in reverse polarity relative to the first series block, or alternating series blocks. For this arrangement, the series block of LED lamps should be manufactured with a substantially equal number of light strings produced with all LEDs in forward bias (anode first) and reverse bias (cathode first). This allows true randomness when large numbers of single series block LED light strings are connected in an end-to-end manner. A simple sorting and test procedure is given later in this text to assist manufacturers and allow for an equal number of forward and reverse bias light strings. It is possible to apply this concept to single LED lamps having two chips where one chip is powered in reverse bias to the second chip; thereby providing a self-canceling harmonics within the single LED lamp. Of course, this self-canceling concept can be employ to any even number of chips in a single LED lamp.

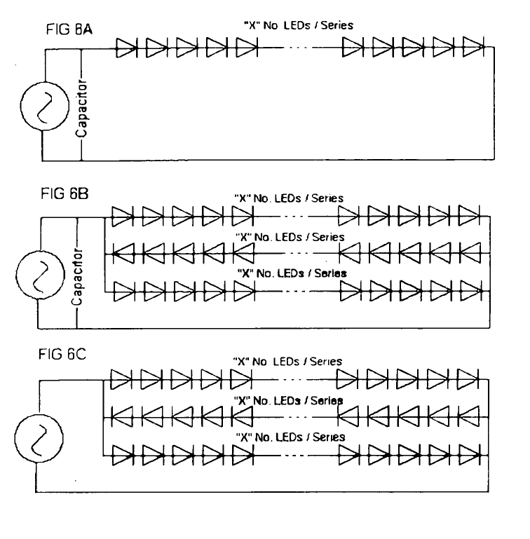

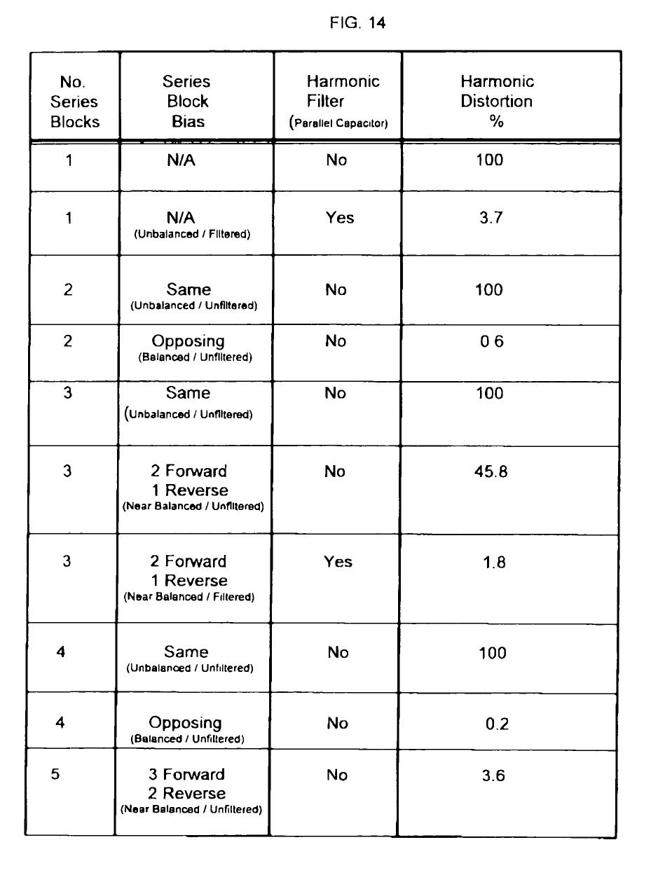

In AC driven LED light strings employing a single series block of LED lamps, whether or not there is a substantially equal number of LEDs in forward bias (anode first) and reverse bias (cathode first), harmonic distortion is greatly reduced when a capacitor is connected in parallel across the AC input, or end connector terminals (FIG. 6A) of the light string. In the one tested embodiment, a 0.01 uF, 500V capacitor at 120 VAC, 60 Hz was used. Incorporating this harmonic filter dramatically reduces harmonic distortion and DC feedback entering into the power grid (see FIG. 14).

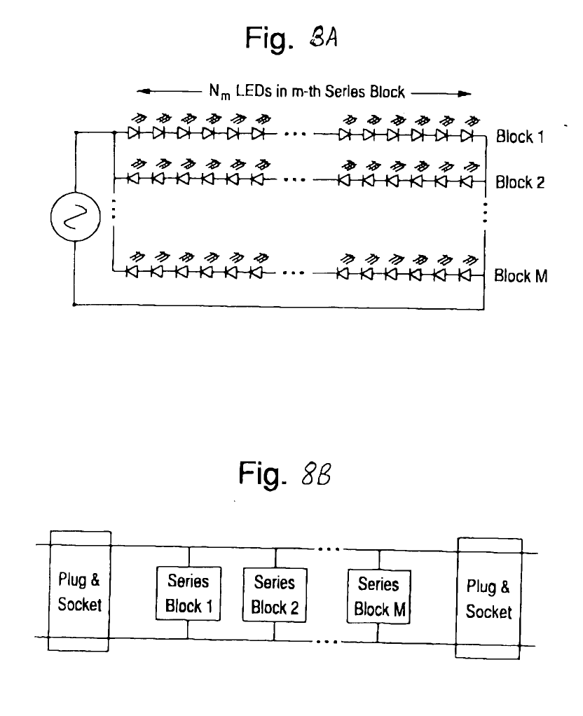

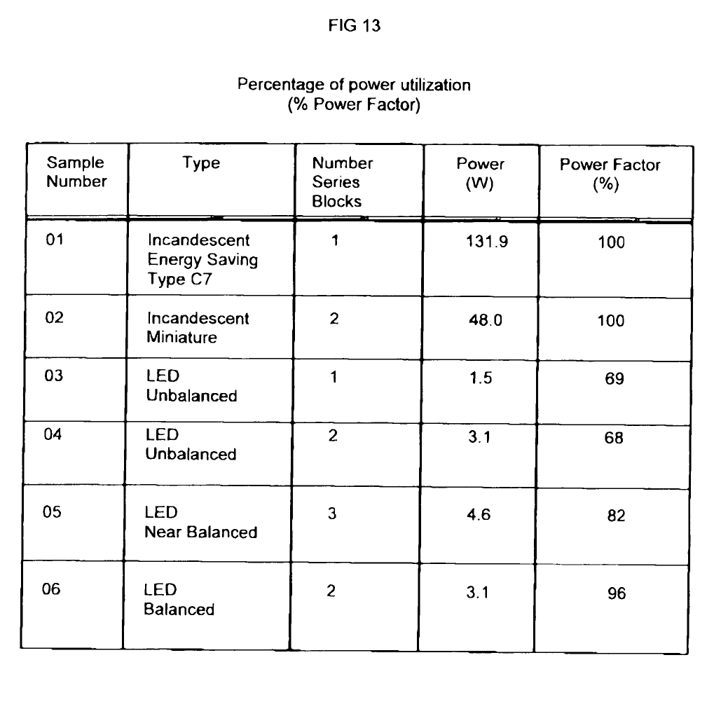

Harmonic distortion is greatly reduced when the number of series blocks oriented in forward bias and reverse bias are nearly equal, differing by a single series block as shown in FIG. 6C and FIG. 8A (near balanced). As the number of series blocks contained in the LED light set increases power utilization improves (FIG. 13) and relative harmonic distortion decreases (FIG. 14).

Harmonic distortion can be further reduced when the number of forward and reverse bias series blocks are nearly equal and a capacitor is connected in parallel across the AC input terminals, or end connection terminals (FIG. 6A and FIG. 6B). It appears as if the harmonic filter (capacitor) is no longer required when 5 or more near balanced series blocks are employed as relative harmonic distortion is decreased to a harmless level.

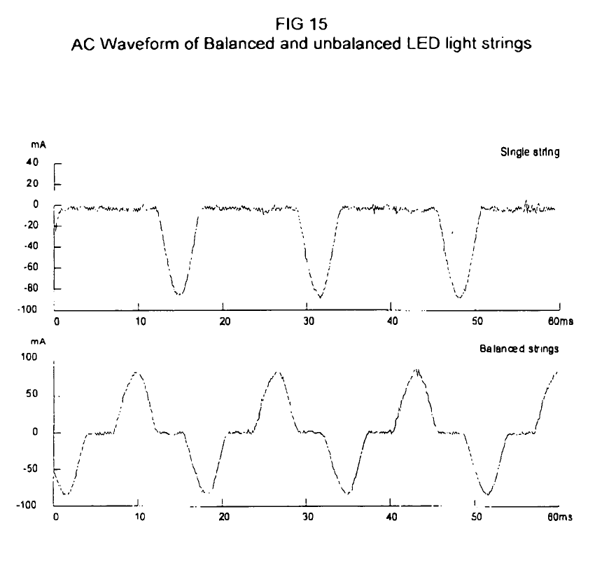

Harmonic balance is achieved (FIG. 15) and power utilization is maximized (FIG. 13) when the number of series blocks oriented in forward bias and reverse bias are equal (FIG. 2B).

It should be noted that the arrangement of forward bias to reverse bias series blocks is not order dependant. The important factor is to maintain an equal, or near equal number of series blocks oriented in forward and reverse polarity (bias).

FIGS. 2A and 2B show two schematic diagram implementations of the top diagram of FIG. 1A, where the simplest example of AC drive is shown that uses two example series blocks of 50 LEDs, connected in parallel and powered by 110 VAC. In the top schematic diagram of FIG. 2A both of these LED series blocks are wired in parallel with the polarity of both blocks in the same direction (or, equivalently, if both blocks were reversed). With this block alignment, both series blocks flash on simultaneously, using electrical power from the positive (or negative, if both blocks were reversed) portion of the symmetric AC power cycle only. This results in poor power utilization and harmonics identical to single series block (unfiltered) LED light strings.

The disadvantage of this configuration is that, since both blocks flash on simultaneously, they both draw power at the same time, and the maximum current draw during this time is as large as possible. A further disadvantage of this arrangement is power utilization is minimized and a high percentage of DC and harmonic distortion enters the utility grid. An example of the AC waveform exhibited by LED light sets using this configuration is shown in FIG. 15 as a single string. The flash rate, at 50-60 Hz, cannot be seen directly by human eye and is instead integrated into a continuous light stream.

FIG. 2B shows the alternative implementation for FIG. 1A, where again, two exemplary series blocks of 50 LEDS are connected in parallel and powered by 110 VAC.

In this alignment, the two series blocks are reversed, relative to each other, in polarity with respect to the input AC power. Thus, the two blocks flash alternatively, with one block flashing on during the negative portion of each AC cycle. The symmetry, or “sine-wave” nature of AC allows this possibility and is shown in FIG. 15 as balanced strings. In accordance with the present invention, the advantage is that, since each block flashes alternatively, drawing power during opposite phases of the AC power, the power utilization of the device is maximized (FIG. 13) and DC interference and harmonic distortion become self-cancelling (FIG. 14), resulting in a harmonically balanced light set.

For AC drive with non-standard input (e.g., three-phase AC) the series blocks may similarly be arranged in polarity to divide power among the individual cycles of the multiple phase AC. This may result in multiple polarities employed for the LED series blocks, say three polarities for each of the three positive or negative cycles.

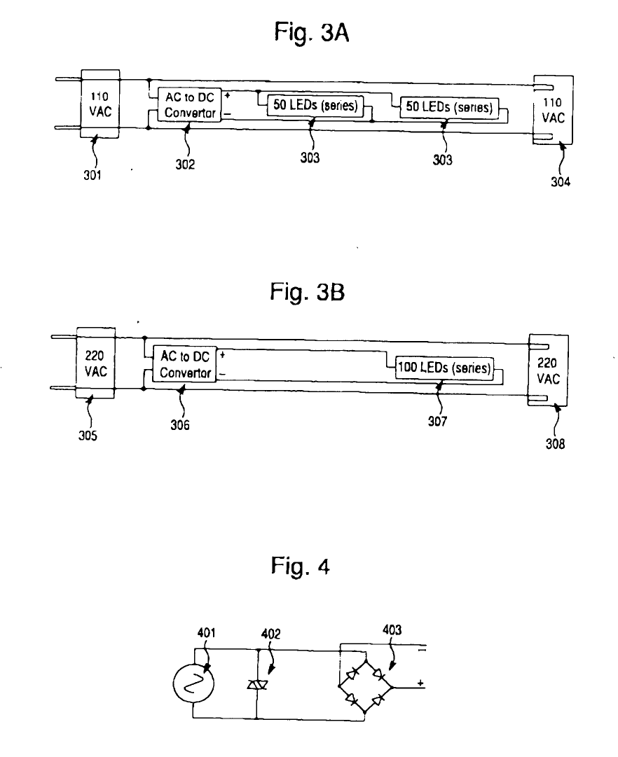

As an alternative preference to AC drive, FIGS. 3A and 3B shows two block diagrams that correspond to an exemplary string employing 100 LEDs and DC drive, for either 110 VAC (top diagram) or 220 VAC (bottom diagram) standard household current input (e.g., 50 or 60 Hz). In the top block diagram of FIG. 3A, the input electrical interface consists of a standard 110 VAC household plug 301 attached to a pair of drive wires, followed by an AC-to-DC converter circuit 302. As in FIG. 1, with the average LED drive voltage assumed to be approximately 2.2 VAC in FIG. 3A, the basic series block size for the top block diagram, corresponding to 110 VAC input, is approximately 50 LEDs. Thus, for the 110 VAC version, two series blocks of 50 LEDs 303 are coupled in parallel to the output of the AC-to-DC converter 302 using additional feed wires along the light string. The two drive wires for the 110 VAC light string terminate in a standard 110 VAC household socket 304 to enable multiple strings to be connected in parallel electrically from end-to-end.

In the bottom block diagram of FIG. 3B, the input electrical interface likewise consists of a standard 220 VAC household plug 305 attached to a pair of drive wires, followed by an AC-to-DC converter circuit 306. With again the average LED drive voltage assumed to be approximately 2.2 VAC in FIG. 3B, the basic series block size for the bottom diagram, corresponding to 220 VAC input, is 100 LEDs. Thus, for the 220 VAC version, only one series block of 100 LEDs 307 is coupled to the output of the AC-to-DC converter 306 using additional feed wires along the light string. The two drive wires for the 220 VAC light string terminate in a standard 220 VAC household socket 308 to enable multiple strings to be connected in parallel from end-to-end. Note that for either the 110 VAC or the 220 VAC light string, the standard plug and socket employed in the string varies in accordance to the country in which the light string is intended to be used.

FIG. 4 shows an example schematic electrical diagram for the AC-to-DC converter employed in both diagrams of FIG. 3. The AC input to the circuit in FIG. 1 is indicated by the symbol for an AC source 401. A varistor 402 or similar fusing device may optionally be used to ensure that voltage is limited during large power surges. The actual AC to DC rectification is performed by use of a full-wave bridge rectifier 403. This bridge rectifier 403 results in a rippled DC current and therefore serves as an example circuit only. A different rectification scheme may be employed, depending on cost considerations. For example, one or more capacitors or inductors may be added to reduce ripple at only minor cost increase. Because of the many possibilities, and because of their insignificance, these and similar additional circuit features have been purposely omitted from FIG. 4.

The same, or substantially similar principals of balanced harmonics and power utilization are applicable to FIGS. 3 and 4 as previously explained and illustrated in this text. Further explanation has been purposefully omitted as being redundant and easily understood by those skilled in the art.

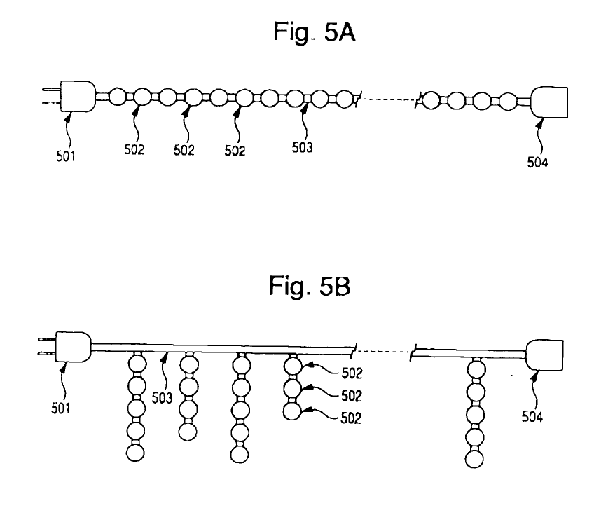

For either the 110 VAC or the 220 VAC version of the LED light string, and whether or not an AC to-DC power converter is used, the final manufacturing may be a variation of either the basic “straight” string form or the basic “curtain” string form, as shown in the top and bottom pictorial diagrams in FIGS. 5A and 5B. In the basic “straight” form of the light string, the standard (110 VAC or 220 VAC) plug 501 is attached to the drive wires which provide power to the LEDs 502 via the series-parallel feeding described previously. The two drive and other feed wires 503 are twisted together along the length of the light string for compactness and the LEDs 502 in the “straight” form are aligned with these twisted wires 503, with the LEDs 502 spaced uniformly along the string length (note drawing is not to scale). The two drive wires in the “straight” form of the light string terminate in the standard (correspondingly, 110 VAC or 220 VAC) socket 504. Typically, the LEDs are spaced uniformly every four inches.

In the basic “curtain” form of the light string, as shown pictorially in the bottom diagram of FIGS. 5A and 5B, the standard (110 VAC or 220 VAC) plug 501 again is attached to the drive wires which provide power to the LEDs 502 via the series-parallel feeding described previously. The two drive and other feed wires 503 are again twisted together along the length of the light string for compactness. However, the feed wires to the LEDs are now twisted and arranged such that the LEDs are offset from the light string axis in small groups (groups of 3 to 5 are shown as an example). The length of these groups of offset LEDs may remain the same along the string or they may vary in either a periodic or pseudo-random fashion.

Within each group of offset LEDs, the LEDs 502 may be spaced uniformly as shown or they may be spaced nonuniformly, in either a periodic or pseudo-random fashion (note drawing is not to scale). The two drive wires in the “curtain” form of the light string also terminate in a standard (correspondingly 110 VAC or 220 VAC) socket 504. Typically, the LED offset groups are spaced uniformly every six inches along the string axis and, within each group, the LEDs are spaced uniformly every four inches.

In any above version of the preferred embodiment to the LED light string, blinking may be obtained using a number of techniques requiring additional circuitry, or by simply replacing one of the LEDs in each series block with a blinking LED. Blinking LEDs are already available on the market at comparable prices with their continuous counterparts, and thus the light string may be sold with the necessary (e.g., one or two) additional blinkers included in the few extra LEDs.

In accordance with the present embodiment FIG. 6A illustrates a single series block of LEDs wherein a capacitor is connected in parallel in order to minimize harmonic distortion when a single series block of LEDs is employed. Additional, optional components to this circuit have been intentionally eliminated as they are known in the art and are not critical to the desired result.

In accordance with the present embodiment FIG. 6B illustrates an unequal number of LED series blocks wherein a capacitor is connected in parallel in order to minimize harmonic distortion.

In accordance with the present embodiment FIG. 6C illustrates a lower cost, near-balanced alternative wherein harmonic distortion is reduced, however, not to the extent afforded by FIG. 6B. As noted earlier in this text, as the total number of series blocks increase, this near balanced alterative approaches the self-cancelling and harmonically balanced design of FIG. 2B. This is further illustrated by FIG. 8A and predicated on the total number of forward bias to reverse bias series blocks being unequal by one.

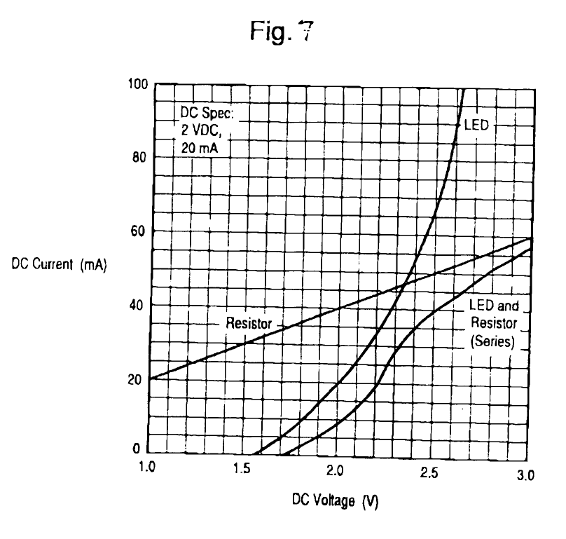

Many LED light string designs use one or more impedance elements in series between the LED network and the power supply while other designs are free of impedance circuitry. Current-saturated transistors are a less common method of current limiting. A resistor is often used for the impedance element due to low cost, high reliability and ease of manufacture from semiconductors. For pulsed-DC or AC power, however, a capacitor or inductor may instead be used as a series block impedance element. With AC power, even though the waveform shape may be changed somewhat by capacitors or inductors, the overall effect of these reactive elements is basically the same as a resistor, in adding constant impedance to the series circuit due to the single AC frequency involved (e.g., 60 Hz). In any case, the fundamental effect of current-limiting circuitry is to partially linearize or limit the highly nonlinear current versus voltage characteristic response curve of the diode, as shown in FIG. 7 and has little or no effect on the harmonics of the circuit.

FIG. 8A shows the preferred embodiment of the invention, wherein a network of diodes, consisting of LEDs, is directly driven by the AC source. Near harmonic balance is achieved without the inclusion of the harmonic filter shown in FIG. 6A and 6B and as stated previously this near balanced alterative approaches the self-cancelling and harmonically balanced design of FIG. 2B as the number of series blocs employed increases. Once again, the difference between positively and negatively oriented series blocks should always be one. Additional elements of this circuit, such as impedance devices have been purposely eliminated from these figures as they are known in the art and have little, or no effect on circuit harmonics. FIG. 8B is a block diagram of the above schematic, where a combination plug/socket is drawn explicitly to show how multiple devices can be directly connected either on the same end or in an end-to-end fashion, without additional power supply wires in between. This end-to-end connection feature is particularly convenient for decorative LED light strings.

The invention in FIGS. 8A and 8B may have additional circuitry, not explicitly drawn, to perform functions other than current limiting. For example, logic circuits may be added to provide various types of decorative on-off blinking. A full-wave rectifier may also be used to obtain higher duty factor for the diodes which, without the rectifier, would turn on and off during each AC cycle at an invisibly high rate (e.g., 50 or 60 Hz). The LEDs themselves may be a mixture of any type, including any size, shape, material, color or lens. One vital feature of the diode network is that all diodes are configured to minimize, or eliminate harmonic interference.

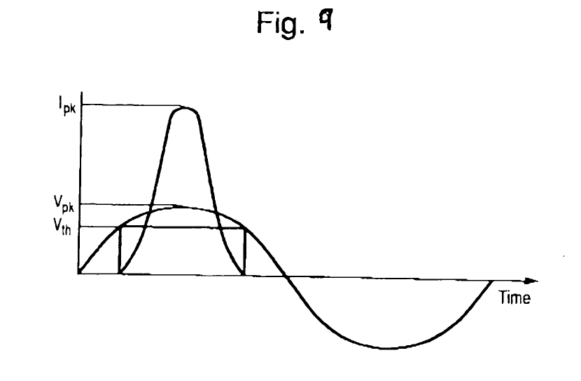

FIG. 9 shows the peak voltage shown, Vₚₖ, is less than or equal to the diode maximum voltage, Vₘₐₓ. For AC voltages below the diode voltage threshold, Vₜₕ, the current is zero. As the voltage increases above Vₜₕ to its peak value, Vₚₖ, and then falls back down again, the diode current rises sharply in a nonlinear fashion, in accordance to its current versus voltage characteristic response curve, to a peak value, Iₚₖ, and then the diode current falls back down again to zero current in a symmetric fashion. Since the voltage was chosen such that Vₚₖ≦Vₘₐₓ, then the peak diode current satisfies Iₚₖ≦Iₘₐₓ. The average diode current, I_{avg}, is obtained by integrating the area under the current spike over one full period. This is in keeping with the balanced and unbalanced AC waveform of LED light strings shown in FIG. 15.

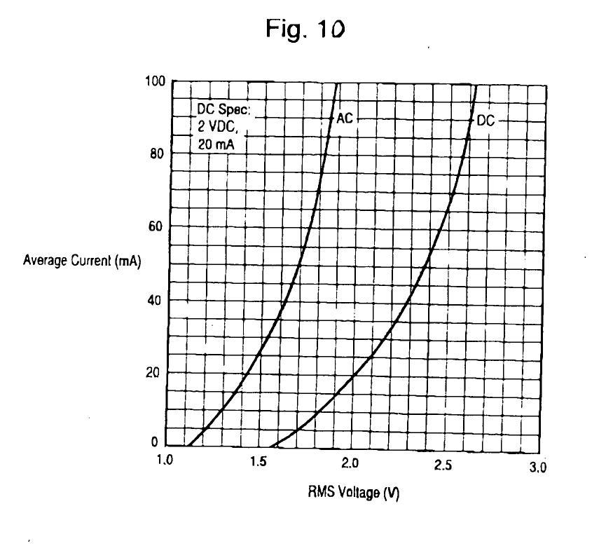

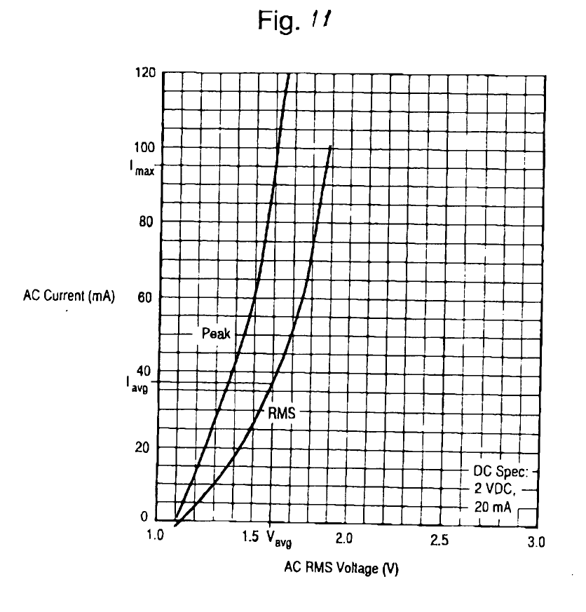

FIG. 10 shows that if one used DC voltages for the diode in an AC circuit, the resulting average AC diode current would be much higher than the DC current expected. This is also in keeping with the balanced and unbalanced AC waveform of LED light strings shown in FIG. 15.

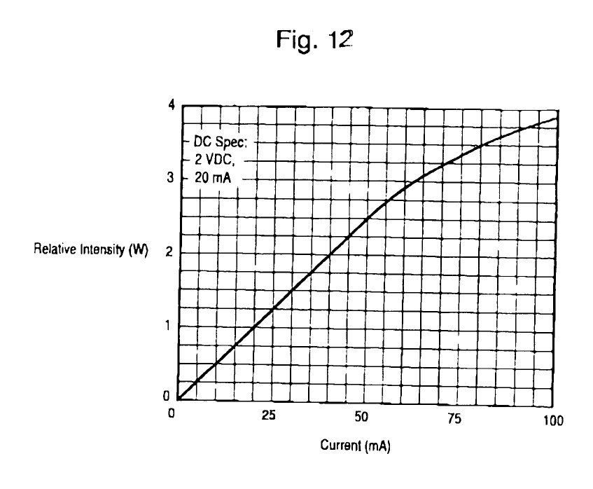

FIG. 12 illustrates the relationship of input current to relative light intensity for LEDs.

FIG. 13 illustrates the power utilization of incandescent, unbalanced, near balanced, and balanced LED light strings in keeping with the present embodiment of this invention.

FIG. 14 illustrates relative DC and harmonic distortion components of unbalanced, unbalanced with a harmonic filter, near balanced, near balanced with a harmonic filter, and harmonically balanced LED light strings. This is in keeping with the present embodiment of this invention and gives graphic representation of the improved harmonics and reduced DC distortion. It should be added that various LED light string designs were tested, including various impedance devices. The results did not deviate from those shown in FIG. 14.

FIG. 15 illustrates the AC waveform for balanced and unbalanced LED light strings in keeping with the present embodiment of this invention.

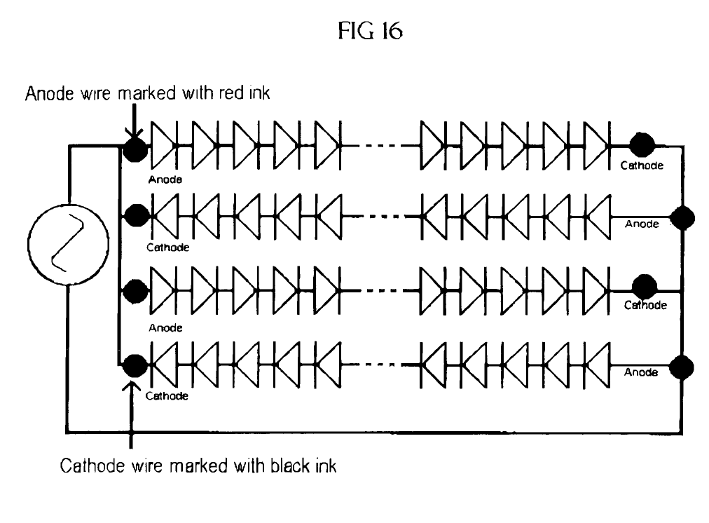

FIG. 16 illustrates a simple, visual method whereby manufacturers can maintain balanced series block polarity within an LED light string. In addition, mechanical methods such as circuit connectors of varying sizes and shapes can also be employed in order to properly orient LED series blocks. An equally simple, yet effective method would be use of an audible tone or visual signal (such as lights of different colour) to identify series block polarity and to assist manufacturing. These details are purposefully omitted due to the broad array of methods that could be employed.

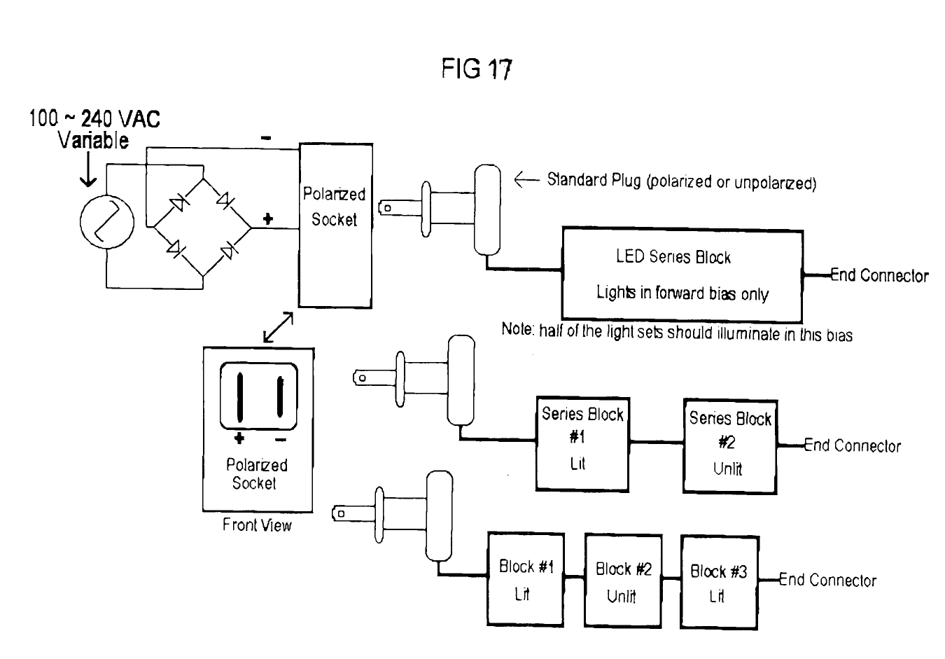

FIG. 17 shows an example test station whereby manufacturers can check series block polarity within LED light strings containing an infinite number of series blocks. The test station employs variable rate, rectified AC power (DC power can be used as an alternative), so a single test station is suitable for testing products being shipped to various countries worldwide. The operator only needs orient the AC plug in the same direction when unpolarized plugs are used (polarized plugs will be self orienting).

LED light sets containing a single series block of LED lights will only illuminate in the positive (forward) bias, making it easy for manufacturers to produce one half of the light sets with positive orientation and one half of the light sets with negative orientation.

When LED light sets containing multiple series blocks are tested, only the series blocks in forward (positive) orientation will illuminate. One half of the series blocks will illuminate in “balanced” LED light strings (as illustrated). The difference between illuminated and non-illuminated series blocks in near balanced LED lights strings will always be one series block.

It will be understood that various changes in the details, materials and arrangements of the parts which have been described and illustrated in order to explain the nature of this invention may be made by those skilled in the art without departing from the principle and scope of the invention as expressed in the following claims.

The foregoing detailed description of the preferred embodiments of the invention has been provided for the purpose of explaining the principles of the invention and its practical application, thereby enabling others skilled in the art to understand the invention for various embodiments and with various modifications as are suited to the particular use contemplated. This description is not intended to be exhaustive or to limit the invention to the precise embodiments disclosed. Modifications and equivalents will be apparent to practitioners skilled in this art and are encompassed within the spirit and scope of the appended claims.

What is claimed is:

1. A light string comprising:
a predetermined number of light emitting diodes (LEDs) and sockets forming individual electrical components electrically coupled in series to form at least one series block, each electrical component defining individual alternating current average drive voltages, the at least one series block having a first electrical component and a last electrical component;
an alternating current electrical power supply having an average supply voltage;
means for reducing harmonic distortion in said at least one series block.

2. The light string of claim 1, wherein said means for reducing harmonic distortion comprises a capacitor electrically connected in parallel across one of the alternating current power supply and an end connector terminal.

3. The light string of claim 1, wherein said means for reducing harmonic distortion comprises an arrangement of said individual electrical components where a first set of said individual electrical components is oriented in a forward bias position and a second set of said individual electrical components is oriented in a reverse bias position, said first set being substantially equal in number to said second set.

4. The light string of claim 3, wherein said first set and said second set are coupled in series within a single series block of said at least one series block.

5. The light string of claim 3, wherein said first set and said second set define individual series blocks electrically connected to improve power utilization and reduce harmonic distortion.

6. The light string of claim 1, wherein said means for reducing harmonic distortion comprises an arrangement of said individual electrical components where at least one first set of said individual electrical components is oriented in a positive forward bias position and at least one second set of said individual electrical components is oriented in a negative reverse bias position to at least partly cancel a harmonic effect of said at least one first set.

7. The light string of claim 6, wherein said at least one first set is substantially equal in number to said at least one second set.

8. The light string of claim 6, wherein said at least one first set differs equal in number from said at least one second set by one.

9. The light string of claim 6, wherein said means for reducing harmonic distortion further comprises a capacitor electrically connected in parallel across one of the alternating current power supply and an end connector terminal.

10. The light string of claim 1, wherein the supply voltage (Vᵣₘₛ) follows the following relationship in order to determine the predetermined number of LEDs:
$${V}_{rms} \leq {\sum }_{n} {V}_{avg} ( n , m )$$
where m is a diode type and n is the predetermined number.

11. The light string of claim 10, where, when, all Nₘ diodes in the m-th series block are of the same type, each with Vᵣₘₛ, then Vₘ<NₘV_{avg}.

12. The light string of claim 1, further comprising a lamp holder having a keyed offset, the lamp holder fixedly attached to each LED, and
a lamp base having a notch adapted to receive the keyed offset of the lamp holder, thereby mechanically orienting and aligning each LED by its polarity.

13. The light string of claim 14, wherein the lamp base further comprises a base keyed offset and a lamp assembly holder, the lamp assembly holder having a notch adapted to receive the base keyed offset.

14. The light string of claim 3, wherein said arrangement comprises a substantial equal number of chips within each light emitting diodes in reverse bias to each other, thereby providing self-canceling harmonics within the single LED lamp.

15. A light string comprising:
a predetermined number of light emitting diodes (LEDs) and sockets forming individual electrical components electrically coupled in series to form at least one series block, each electrical component defining individual alternating current average drive voltages, the at least one series block having a first electrical component and a last electrical component;
an alternating current electrical power supply having an average supply voltage;
at least one additional circuitry component electrically connected to said at least one series block, said at least one additional circuitry component reducing harmonic distortion and improve power utilization in said at least one series block.

16. The light string of claim 15, wherein said means for reducing harmonic distortion comprises a capacitor electrically connected in parallel across one of the alternating current power supply and an end connector terminal.

17. The light string of claim 15, wherein said means for reducing harmonic distortion comprises an arrangement of said individual electrical components where a first set of said individual electrical components is oriented in a forward bias position and a second set of said individual electrical components is oriented in a reverse bias position, said first set being substantially equal in number to said second set.

18. The light string of claim 17, wherein said first set and said second set are coupled in series within a single series block of said at least one series block.

19. The light string of claim 17, wherein said first set and said second set define individual series blocks electrically connected to improve power utilization and reduce harmonic distortion.

20. The light string of claim 15, wherein said means for reducing harmonic distortion comprises an arrangement of said individual electrical components where at least one first set of said individual electrical components is oriented in a forward bias position and at least one second set of said individual electrical components is oriented in a reverse bias position to at least partly cancel a harmonic effect of said at least one first set.

21. The light string of claim 20, wherein said at least one first set is substantially equal in number to said at least one second set.

22. The light string of claim 20, wherein said at least one first set differs equal in number from said at least one second set by one.

23. The light string of claim 20, wherein said means for reducing harmonic distortion further comprises a capacitor electrically connected in parallel across one of the alternating current power supply and an end connector terminal.

24. The light string of claim 17, wherein said arrangement comprises a substantial equal number of chips within each light emitting diodes in reverse bias to each other, thereby providing self-canceling harmonics within the single LED lamp.

25. A method for testing the polarity of the light string of claim 1, comprising the steps of:
illuminating LEDs of said at least one series block oriented in a positive forward bias position;
modifying a number of LEDs in said light string to include additional LEDS oriented in a negative reverse bias position to thereby reduce harmonic distortion of said light string.
